(19) United States
(12) Patent Application Publication
(10) Pub. No.: US 2023/0201728 A1
(43) Pub. Date: Jun. 29, 2023

(54) STRUCTURE OF HORIZONTAL AND VERTICAL PLACEMENT FOR THE PS5 CONSOLE

(71) Applicant: GUANGZHOU ZHONGTIANXIN ELECTRONIC TECHNOLOGY CO.,LTD, Guangzhou (CN)

(72) Inventor: Zhenghui FU, Guangzhou (CN)

(73) Assignee: GUANGZHOU ZHONGTIANXIN ELECTRONIC TECHNOLOGY CO.,LTD, Guangzhou (CN)

(21) Appl. No.: 17/871,518

(22) Filed: Jul. 22, 2022

(30) Foreign Application Priority Data
Dec. 29, 2021 (CN) 2021233743087

(51) Int. Cl. A63F 13/98

(52) U.S. Cl. CPC A63F 13/98

(57) ABSTRACT

This utility model patent discloses a structure of horizontal and vertical placement for the PS5 console, comprising the first stand and the second stand. As described the first stand is equipped with the first buckle and installation shell. The second buckle is on the installation shell. The one side of installation shell has a cover plate and cooling fans are set between installation shell and cover plate. This structure will be stable by the setting of the first buckle and second buckle, third buckle, and fourth buckle, as well as connecting with screw. Through the opening mold of the first hollow slot and the second hollow slot, it not only can save cost, but also can bring a better user experience and meet the demands of customers. With the aid of cooling fans, this model improves the heat dissipation of the PS5 in order to use for a long time.

### CROSS-REFERENCE TO RELATED APPLICATIONS

The application claims priority to Chinese patent application No. 2021233743087, filed on Dec. 29, 2021, the entire contents of which are incorporated herein by reference.

### TECHNICAL FIELD

The utility model relates to the technical field of game console stand, in particular to a structure for the horizontal and vertical placement of PS5 consoles.

### BACKGROUND

Because playstation consoles are often used with stand to improve the user experience by clients, and the game console stand on this market can only make the playstation console place horizontally or vertically which is unable to meet the needs of the PS5 console for diverse placement and diverse placement spaces. Therefore, at this stage, a new model of structure for the horizontal and vertical placement of the PS5 console is urgently needed.

### Utility Model Content

The purpose of this invention is to provide a structure for placing the PS5 console horizontally and vertically, so as to solve the problems raised in the above background.

In order to solve the above-mentioned technical problems, the utility model provides the following technical solutions: A structure of horizontal and vertical placement for the PS5 console, comprising the first stand and the second stand. As described the first stand is equipped with the first buckle and installation shell. The second buckle is on the installation shell. The one side of installation shell has a cover plate. There are cooling fans set between installation shell and cover plate. Screw thread is on the installation shell which can cross the cover plate to connect with PS5 console. The third buckle and fourth buckle are set on the second stand.

Further, cooling fans will be set on the installation shell and cover plate.

Further, the first stand has a power cord which one end is connected to cooling fans and the other end is connected to PS5 console.

Further, the second stand has gaskets.

Further, the first stand has the first hollow slot and the second stand has the second hollow slot.

Compared with existing technology, the utility model has the advantages that the new model has simple structure and is convenient to use which can meet the needs of PS5 console for horizontal and vertical placement. This structure will be stable by the setting of the first buckle and second buckle, third buckle, and fourth buckle, as well as connecting with screw. Though the opening mold of the first hollow slot and the second hollow slot, it not only can save cost, but also can bring better user experience and meet the demands of customers. With the aid of cooling fans, this model improves the heat dissipation of the PS5 in order to use for a long time.

### BRIEF DESCRIPTION OF DRAWINGS

The accompanying drawings are used to provide a further understanding of this utility model and to constitute a part of instruction and are used to explain this utility model together with implementation and do not constitute a limitation to the utility model.

In the accompanying drawing:

FIG. 1 is the three-dimensional structure schematic diagram of the first stand in this utility model;

FIG. 2 is the three-dimensional structure schematic diagram of the second stand in this utility model;

FIGS. 3 and 4 is the schematic diagram of the horizontal placement demonstration of the utility model;

FIGS. 5 and 6 is the schematic diagram of the vertical placement demonstration of the utility model;

In the figure: 1. The first stand; 2. The second stand; 3. The first buckle; 4. The second buckle; 5. The third buckle; 6. The fourth buckle; 7. The screw; 8. The installation Shell; 9. Cover plate; 10. Power cord; 11. Gasket; 12. The first hollow slot; 13. The second hollow slot; 14. Heat dissipation hole.

### DETAILED DESCRIPTION OF THE EMBODIMENTS

The following will be clearly and completely described for technical solutions in the implementation of the utility model. Obviously, the described implementations are only a part of implementation of this utility model, but not all of the implementations. Based on the implementation of the this utility model, ordinary technical personnel in this field who obtained all other implementation without creative work all belong to the scope of protection of this utility model.

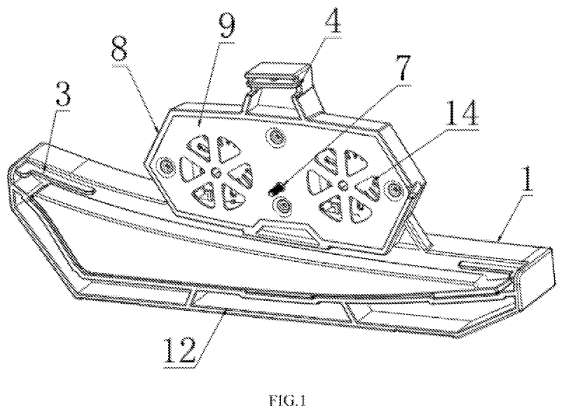

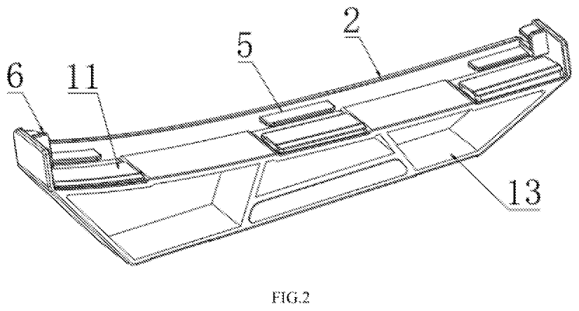

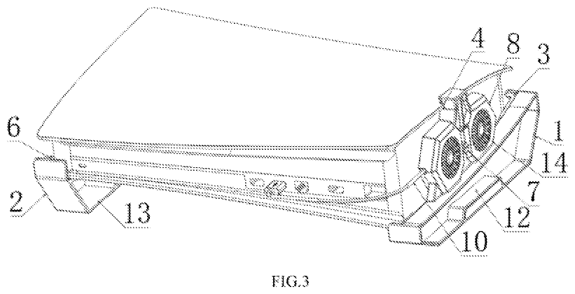

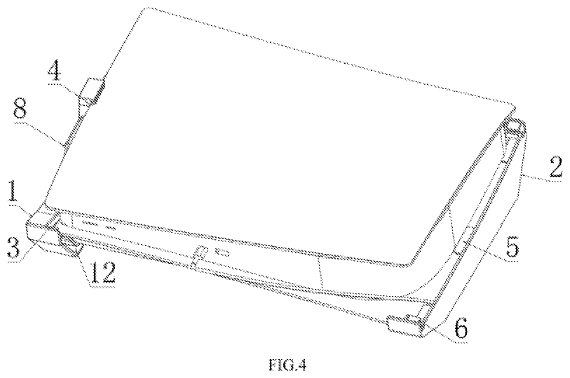

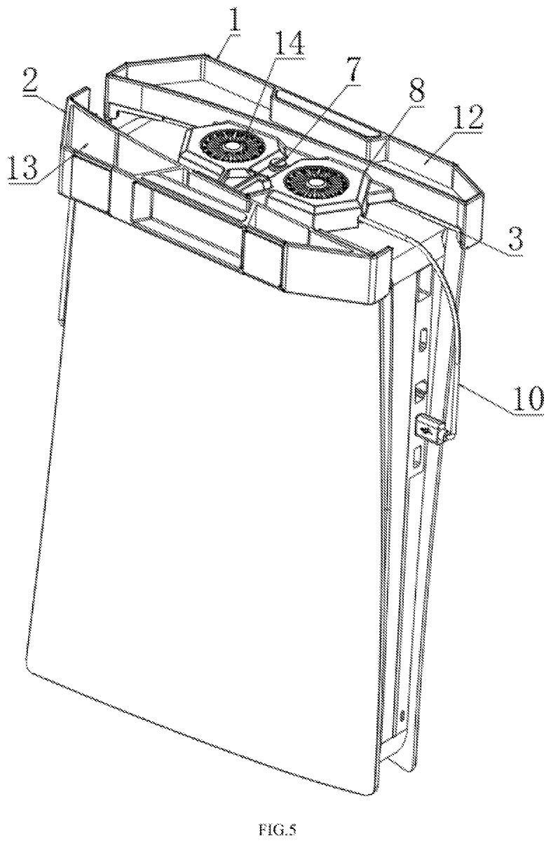

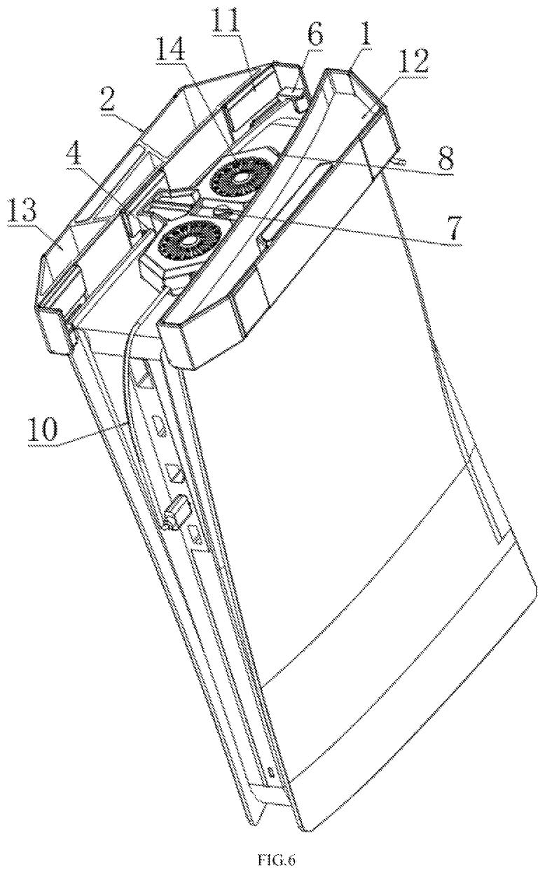

Please refer to FIGS. 1-6, this utility model provides a technical solution:

Implementation 1:

A structure of horizontal and vertical placement for the PS5 console, comprising the first stand 1 and the second stand 2. The first stand 1 is equipped with the first buckle 3 and installation shell 8. The second buckle 4 is on the installation shell 8. The one side of installation shell 8 has a cover plate 9. There are cooling fans set between installation shell 8 and cover plate 9. Screw thread 7 is on the installation shell 8 which can cross the cover plate 9 to connect with PS5 console. The third buckle 5 and fourth buckle 6 are set on the second stand 2. The first stand 1 will be installed stably on the one side of PS5 console with the assist of the first buckle 3 and the second buckle 4. The second stand 1 will be installed stably on the other side of PS5 console with the assist of the third buckle 5 and the fourth buckle 6. There are cooling holes 14 on the installation shell 8 and the cover plate 9. The first stand 1 has power cord 10 which one end is connected to cooling fans and the other end is connected to PS5 console. The second stand 2 has gasket 11. The first stand 1 has the first hollow slot 12 and the second stand 2 has the second hollow slot 13.

Implementation 2:

A structure of horizontal and vertical placement for the PS5 console, comprising the first stand 1 and the second stand 2. The first stand 1 is equipped with the first buckle 3 and installation shell 8. The second buckle 4 is on the installation shell 8. The one side of installation shell 8 has a cover plate 9. There are cooling fans set between installation shell 8 and cover plate 9. Screw thread 7 is on the installation shell 8 which can cross the cover plate 9 to connect with PS5 console. The second stand 2 is provided with the third buckle 5 and the fourth buckle 6 respectively, and the fourth buckle 6 and the second buckle 4 are connected with each other. The first stand 1 and the second stand 2 will be installed stably on the side of PS5 console with the assist of the first buckle 3, the second buckle 4, the third buckle 5 and the fourth buckle 6. There are cooling holes 14 on the installation shell 8 and the cover plate 9. The first stand 1 has power cord 10 which one end is connected to cooling fans and the other end is connected to PS5 console. The second stand 2 has gasket 11. The first stand 1 has the first hollow slot 12 and the second stand 2 has the second hollow slot 13.

Working Principle: when using this structure for placing PS5 console horizontally and vertically, in horizontal placement. PS5 console is locked by the third buckle 5 of the second stand 2 and the first buckle 3 and the second buckle 4 of the first stand 1. At the same time, the first stand 1 is fixed on the PS5 console by screw 7 to complete the PS5 horizontal placement assembly. In vertical placement. PS5 console is locked by the fourth buckle 6 of the second stand 2 at first, then locked by the first buckle 3 and the second buckle 4 of the first stand 1. At the same time, the second buckle 4 and the fourth buckle 6 are engaged with each other to fix the second stand 2. Finally fixed on the PS5 console with screw to complete the vertical placement assembly.

It should be noted that, in this document, relational terms such as the first and the second am used only to distinguish one entity or operation from another entity or operation, and do not necessarily require or imply any relationship between these entities or operations. Moreover, the terms “comprise”, “include” or any other variation thereof are intended to encompass a non-exclusive inclusion such that a process, method, article or device comprising a list of elements includes not only those elements, but also includes no explicit other elements listed, or includes elements inherent to such process, method, article or device.

Finally, it should be noted that the above are only the preferred implementation of this utility model, and are not intended to limit the utility model. Although the utility model has been described in detail with reference to the foregoing implementation, those skilled in the field can still modify the technical solutions described in the foregoing implementation, or perform equivalent replacements for some of the technical features. Any modification, equivalent replacement, improvement, etc. made within the spirit and principle of the utility model shall be included in the protection scope of the utility model.

What is claimed is:

1. A structure of horizontal and vertical placement for the PS5 console, comprising the first stand (1) and the second stand (2), its characteristics are as follows, as described the first stand (1) is equipped with the first buckle (3) and installation shell (8), the second buckle (4) is on the installation shell (8), the one side of installation shell (8) has a cover plate (9), there are cooling fans set between installation shell (8) and cover plate (9), screw thread (7) is on the installation shell (8) which can cross the cover plate (9) to connect with PS5 console, The third buckle (5) and fourth buckle (6) are set on the second stand (2).

2. According to the structure for PS5 console of horizontal and vertical placement mentioned in claim 1, wherein the installation shell (8) and the cover plate (9) are provided with cooling holes (14).

3. According to the structure for PS5 console of horizontal and vertical placement mentioned in claim 1, wherein the first stand (1) has power cord (10) which one end is connected to cooling fans and the other end is connected to PS5 console.

4. According to the structure for PS5 console of horizontal and vertical placement mentioned in claim 1, wherein the second stand (2) has gaskets (11).

5. According to the structure for PS5 console of horizontal and vertical placement mentioned in claim 1, wherein the first stand (1) has the first hollow slot (12) and the second stand (2) has the second hollow slot (13).
